(19) United States
(12) Patent Application Publication
(10) Pub. No.: US 2008/0123918 A1
(43) Pub. Date: May 29, 2008

(54) IMAGE PROCESSING APPARATUS

(75) Inventors: Akiko Saotome, Kanagawa (JP); Masayuki Takahira, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/772,529

(22) Filed: Jul. 2, 2007

(30) Foreign Application Priority Data
Jun. 30, 2006 (JP) 2006-181656

(51) Int. Cl. G06K 9/00

(52) U.S. Cl. 382/128

(57) ABSTRACT

There is provided an image processing apparatus by which images sent from different modalities are simultaneously displayed on one monitor, such that even when at least one monochromatic image is displayed together with at least one color image, the at least two images can be easily reproduced to have optimum gradations associated with the images. The image processing apparatus includes an identifying device which identifies types of modalities from which the image data have been sent, a correcting device which applies look-up tables or correction coefficients for gradation corrections in accordance with the respective modalities to the image data and performs gradation correction corresponding to the characteristic of the monitor on the image data, and a position setting device which sets positions on a display screen of the monitor in which the diagnostic images are to be displayed.

The entire contents of documents cited in this specification are incorporated herein by reference.

### BACKGROUND OF THE INVENTION

The present invention relates to an image processing apparatus that displays more than one piece of image data on a single display means.

Constructed in medical settings are image display systems by which digitized medical image data obtained from medical diagnostic apparatuses (hereinafter sometimes referred to as modalities) such as CR apparatus, CT apparatus, MRI apparatus, endoscopic apparatus, ultrasonic diagnostic apparatus (echographs), etc. are transferred to image display apparatuses for image display.

In addition, with the recent advances in color display technology, it has also become possible to provide a color display of X-ray image and other monochromatic images that require high luminance and high gradation characteristics. This has brought a demand for operating medical image display systems in such a way that both a color image and a monochromatic image are displayed together on a single monitor.

In order to display a plurality of images together on a single monitor, the respective images have to be subjected to independent processing of gradation correction in association with their gradation characteristics. As a method of meeting this need, JP 63-246788 A discloses an invention in which a plurality of look-up table (LUT) memories are provided in parallel such that individual images are independently adjusted in lightness and contrast. According to this invention, a plurality of LUTs which are as many as the images to be displayed are provided and the operator, while looking at the TV monitor, independently adjusts the respective images in terms of lightness and contrast, whereby the plurality of images can be simultaneously displayed to have appropriate gradations.

In addition, JP 62-136695 A discloses a method in which a plurality of LUT conversion tables are searched by identifier numbers to find LUT conversion tables that correspond to the images on display and the chosen LUTs are processed by colors commanded by their application programs, whereby appropriate gradation processing is applied to the individual images to be displayed.

### SUMMARY OF THE INVENTION

However, in order to implement the method of JP 63-246788 A, gradation correction is performed manually after images are displayed and this involves cumbersome operation; in addition, as more images need to be displayed, the amount of work to be done by the operator increases to make the method less efficient. What is more, both of the methods described in JP 63-246788 A and JP 62-136695 A require that the maximum number of images to be displayed simultaneously should be predetermined but then the individual images cannot be efficiently corrected in gradation.

Further in addition, if the image data being transferred from a modality is smaller than the number of bits that can be displayed on the monitor, gradation conversion is performed to expand the image data to a size that matches the bit number of the monitor. However, the conventional method of gradation conversion is such that the gradation of the image data is simply rendered to be proportional to the monitor's bit number without making full use of the gradation characteristics of the monitor.

In the case where a plurality of medical images are displayed simultaneously, for instance, when a monochromatic image such as an X-ray image that requires high luminance is displayed together with a color image that does not require as high luminance as the monochromatic image, the color image sometimes appears to be too light or too bright compared with the monochromatic image. In this case, the viewer's eye is adapted to the lightness or brightness of the color image and the monochromatic image, although it has not changed at all, looks subdued to become less visible than the color image and its diagnostic performance is lowered.

A further problem is associated with the fact that the reference whiteness and color temperature differ from one modality to another; when a plurality of images obtained from different modalities are displayed on one monitor or when images obtained from different modalities are displayed on as many monitors placed side by side, the viewer's eye is also adapted to an image having a higher degree of reference whiteness or a higher color temperature, with the result that the viewer feels the difference between two color temperatures to be greater than it actually is.

An object, therefore, of the present invention is to solve the aforementioned problems of the prior art and it provides an image processing apparatus by which a plurality of images sent from different modalities are simultaneously displayed on one monitor, such that even when a monochromatic image is displayed together with a color image, the two images can be easily reproduced to have optimum gradations that are associated with the gradation characteristics of the modalities and with the luminance setting of the monitor, as well as having a gradation that is associated with the gradation characteristics of the monitor.

In order to achieve the above-mentioned object, according to an aspect of the present invention, there is provided an image processing apparatus that performs image processing on diagnostic images from medical diagnostic apparatuses and produces output images on a monitor, comprising:

identifying means which identifies respective types of said medical diagnostic apparatuses from which said diagnostic images have been sent;

correcting means which has correcting conditions as set for said respective types of said medical diagnostic apparatuses and which performs gradation corrections on said diagnostic images under one of said correcting conditions corresponding to one type of said medical diagnostic apparatuses as identified by said identifying means; and

position setting means which sets positions on a display screen of said monitor in which said diagnostic images are to be displayed.

In the above image processing apparatus, preferably, said correcting conditions are look-up tables for processing said diagnostic images.

Further, preferably, said look-up tables are also used to expand number of gradations in said diagnostic images to match display capacity of said monitor.

Further, preferably, said correcting conditions are either correction coefficients in mathematical operations for correcting said diagnostic images or means for calculating the correction coefficients in the mathematical operations for correcting said diagnostic images, or both.

Further, preferably, said mathematical operations also expand number of gradations in said diagnostic images to match display capacity of said monitor.

According to the present invention, if a plurality of images sent from different medical diagnostic apparatuses are to be simultaneously displayed on one monitor, they are subjected to gradation corrections that are associated with the respective medical diagnostic apparatuses; as a result, even when a monochromatic image is displayed together with a color image, the two images can be easily reproduced to have optimum gradations that are associated with the gradation characteristics of the respective medical diagnostic apparatuses, as well as with the luminance and color temperature settings of the monitor. As a further advantage, image display is possible with the gradation characteristics of the monitor being fully exploited to provide a smooth gradation.

### BRIEF DESCRIPTION OF THE DRAWINGS

FIG. 1 is a block diagram showing a first embodiment of an image display system having the image processing apparatus of the present invention.

FIG. 2 is a block diagram showing a second embodiment of the image display system having the image processing apparatus of the present invention.

### THE PREFERRED EMBODIMENTS OF THE INVENTION

On the following pages, an image display system having the image processing apparatus of the present invention is described.

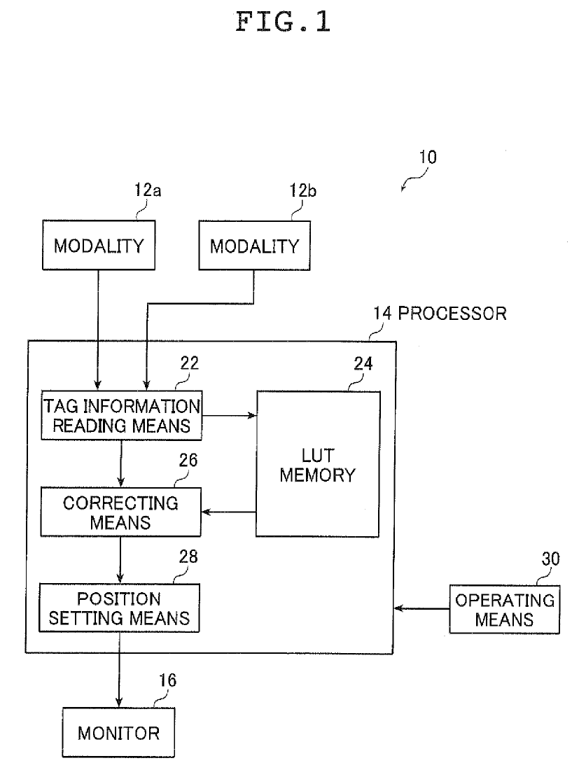

FIG. 1 is a block diagram showing a first embodiment of the image display system having the image processing apparatus of the present invention.

The image display system generally indicated by 10 in FIG. 1 has a medical diagnostic apparatuses 12 (which are hereinafter referred to as modalities 12), the image processing apparatus 14 (which is hereinafter referred to as the processor 14), and a monitor 16.

The modalities 12 (12a and 12b) are medical diagnostic apparatuses such as CR apparatus, CT apparatus, MRI apparatus, endoscopic apparatus, an ultrasonic diagnostic apparatus (echographs), and the like; the modalities 12a and 12b are different modalities, as typically exemplified by a CR apparatus and an MRI apparatus. In FIG. 1, only two modalities 12 are shown but it should be noted that the processor 14 may be connected to three or more modalities 12.

Modalities 12 are each basically a known medical diagnostic apparatus; the image data of a diagnostic picture it has taken or the image data of a diagnostic picture it has read from an external imaging medium is labeled with identifying information (which is hereinafter referred to as an identification tag) for identifying each modality 12 (at least its type) and the image data is then output to a predetermined site such as the processor 14 described below or any other site that may be optionally designated by the operator.

The processor 14 performs gradation corrections (to be described later) on the image data of the diagnostic images obtained from the modalities 12 and outputs the thus corrected image data to the monitor 16.

In the illustrated image display system 10, the processor 14 acquires image data directly from the modalities 12 but it should be understood that this is not the sole case of the present invention and that image data can of course be acquired from a variety of sites such as an image network system formed by utilizing DICOM (Digital Image and Communication in Medicine, or Standards for Transmission of Medical Image Data, Waveform Data, etc.; the processor 14 is integrated into this image network system) and diagnostic image servers to which the processor 14 is connected.

In the illustrated case, the processor 14 has a tag information reading means 22 for reading the identification tags on the image data received from the modalities 12, a LUT memory 24 for storing modality gradation correcting look-up tables (which are hereinafter referred to as modality LUTs) that are associated with the respective modalities 12, a correcting means 26 which performs gradation corrections on the image data using the modality LUTs, and a position setting means 28 which determines the positions in which the image data are displayed on the screen of the monitor 16.

The processor 14 may typically be configured using a personal computer or the like, with operating means 30 such as a keyboard and a mouse being connected to the processor 14.

The tag information reading means 22 reads the identification tags attached to the image data received from the respective modalities 12 and uses them as a key to identify the modalities 12 from which the image data have been sent. The tag information reading means 22 forwards the result of identification to the LUT memory 24.

The LUT memory 24 is a memory for storing the modality LUTs so that gradation correction is performed in association with each of the modalities 12.

The modality LUTs referred to above are look-up tables for gradation correction that are preliminarily constructed in association with the gradation characteristics of the respective modalities and the luminance setting of the monitor 16. In other words, as many modality LUTs as the modalities are constructed and stored in the LUT memory 24.

Diagnostic images have desirable display characteristics that vary with the types of modalities. For instance, compared with the color image as from an MRI apparatus, the X-ray image that is output as from a CR apparatus is required to have a high luminance and a large number of gradations since it is a monochromatic image.

If one monitor is associated with one type of modality, there is no problem with such a single-mode display. However, as mentioned above, there may be a case where a plurality of images, such as a color image and a monochromatic image, that are required to have different gradation characteristics are displayed together on one monitor; in this case, if the display characteristics are adapted to the monochromatic image, problems will occur such as the color image looking unduly light.

The modality LUTs are intended to solve these inconveniences; when images from different modalities, for example, a monochromatic diagnostic image and a color diagnostic image are displayed together on one monitor, the modality LUTs perform gradation corrections on the images from the respective modalities such that either image will have gradation characteristics that are appropriate for the modality from which it has been supplied.

In the illustrated case, the monitor 16 has its luminance set in association with the modality 12 for which the highest display luminance is required. The modality LUT is constructed for each modality 12 such that in accordance with the combination of the luminance setting of the monitor 16 and the modality 12, the image displayed on the monitor 16 will have the appropriate gradation characteristics that are associated with that modality 12.

The LUT memory 24 stores these modality LUTs.

By being thus furnished with the modality LUTs which are gradation correcting look-up tables that have been set for the respective modalities 12, the illustrated processor 14 has the advantage that when a plurality of images supplied from different modalities 12 are displayed together on the monitor 16, each image can be processed to have the appropriate gradation characteristics that are associated with the modality 12 from which it has been supplied; as a result, high-quality diagnostic images are displayed together to ensure that accurate and appropriate diagnosis can be performed rapidly.

With the image display system 10, the modality LUTs may be stored in the LUT memory 24 after being constructed externally; alternatively, they may be stored in the LUT memory 24 after being constructed automatically within the processor 14 in response to a change in the maximum luminance setting of the monitor 16 or the like.

Note that the modality LUTs may be constructed by a known method that is generally employed to construct gradation correcting LUTs used in a monitor for the single-mode display.

In a preferred mode of the modality LUTs, if the display capacity of the monitor 16 (the number of gradations in a display) is higher than the number of gradations in the input image data, the modality LUTs are used not only to perform the above-described gradation corrections but also to expand the gradations in the image data to match the display capacity of the monitor 16.

For instance, if the supplied image data has a capacity of 8 bits (256 gradations) whereas the monitor has a display capacity of 10 bits, the modality LUTs are used not only to perform gradation corrections but also to expand the image data from 8 bits to 10 bits.

As already mentioned, the processor 14 is configured using a PC or the like. In PCs, image data are most commonly handled as 8-bit image data having 256 gradations. On the other hand, recent years are seeing an improvement in the display capacity of monitors and not a few models are capable of displaying more than 8 bits of gradations, say, 10 bits of gradations. Thus, the existing image display systems are not fully exploiting the gradation characteristics of the monitors.

Furthermore, if the diagnostic image is a monochromatic image that is output from a CR apparatus or the like, it is required to display an image of high luminance and high gradation, as already mentioned above.

To meet those requirements, the modality LUTs perform not only gradation corrections but they also expand the gradation of the input image to match the display capacity of the monitor; as a result, when a plurality of images supplied from different modalities are to be displayed together on the monitor, the gradation of each image is processed, as mentioned above, to have the appropriate gradation characteristics that are associated with the modality from which it has been supplied and, in addition, the monochromatic image (or its window) that is output from a CR apparatus or the like is processed to become a monochromatic image of high luminance and high gradation whereas the color image (or its window) that is output from an MRI apparatus or the like is processed to become a color image having an appropriate luminance with satisfactory visibility.

Note that gradation expansion may be performed in accordance with a known method that employs LUTs.

The LUT memory 24, having received from the tag information reading means 22 the result of identification of the modality 12 from which a particular image was sent, uses that result of identification to search for the modality LUT associated with that modality 12 and sends the pertinent modality LUT to the correcting means 26.

Using the modality LUT it has received from the LUT memory 24, the correcting means 26 performs gradation correction on the image data.

The position setting means 28 sets the position in which the image data supplied from each modality 12 (or the window in which the image is to be displayed) is displayed on the screen of the monitor 16.

To be more specific, the position setting means 28 determines where on the display screen of the monitor 16 the image supplied from the modality 12a is to be displayed and where the image supplied from the modality 12b is to be displayed.

The conventional display of diagnostic images is commonly by a single-mode display in which one monitor is associated with one type of modality. In contrast, the processor 14, being furnished with the position setting means 28, enables combination display in which the images supplied from different modalities 12, as exemplified by the modality 12a and the modality 12b, are presented on a single display screen.

The positions in which the images are to be displayed may be fixed positions that are preliminarily set for the respective modalities; alternatively, the operator may manipulate the operating means 30 and the like to enter instructions for appropriate positions, or the modalities 12 may give such instructions. The data on the thus set positions for image display is sent as position information to the monitor 16 together with the image data.

It goes without saying that in addition to the above-described gradation correction and gradation expansion, a variety of image processing procedures that are followed in known diagnostic image display systems may be performed as required and they include color/density correction, defective pixel correction, sharpening, and conversion to image data that is associated with the display on the monitor 16 and the like.

The monitor 16 receives the image data and the position information from the processor 14 and displays the image data on the screen in the positions that are associated with the position information it has received; having this function, the monitor 16 can utilize all kinds of known display means such as LCD, CRT, etc.

On the basis of the position information it has received, the monitor 16 manipulates the operating means 30 and the like to display the image data on the screen of the monitor 16.

In the next place, the method of correcting the gradation of the image data in the image display system 10 of the present invention and the method of displaying images with that system are described in detail.

As already mentioned, each of the modalities 12 attaches an identification tag to the image data of a diagnostic picture it has taken or the image data of a diagnostic picture it has read from an external imaging medium, and outputs such image data to the processor 14.

The processor 14, having received the image data and the identification tags, reads the tag information on the image data in the tag information reading means 22, and identifies the modalities 12 from which the image data have been sent. The information about the identified modalities 12 is forwarded to the LUT memory 24.

The LUT memory 24, having received from the tag information reading means 22 the result of identification of the modality 12 from which a particular image was sent, uses that result of identification to search for the modality LUT based on the gradation characteristics of that modality 12 and sends the pertinent modality LUT to the correcting means 26. Using the modality LUT it has received, the correcting means 26 performs the gradation correcting procedure on the image data.

The image data that have been subjected to the gradation correction are sent to the position setting means 28.

The position setting means 28 sets the positions on the screen in which the image data it has received are to be displayed on the monitor 16. As already mentioned, the image display positions may be fixed positions that are preliminarily set for the respective modalities; alternatively, the operator may manipulate the operating means 30 to designate the appropriate positions, or the modalities 12 may give the necessary instructions.

When the display positions have been determined, the processor 14 supplies the monitor 16 with both the gradation-corrected image data and the position information which shows the positions in which the image data are to be displayed.

The monitor 16, having received the image data and the position information from the processor 14, uses that position information to determine the positions on the screen in which the image data are to be displayed, and subsequently displays the respective images.

According to the image display system 10 having the image processing apparatus 14 described above, if a plurality of images sent from different modalities 12 are to be simultaneously displayed on the monitor 16, they are subjected to gradation corrections by applying look-up tables that are associated with the gradation characteristics of the respective modalities 12 and with the luminance setting and the gradation characteristics of the monitor 16; as a result, even when a monochromatic image is displayed together with a color image, the two images can be easily reproduced to have optimum gradations that are associated with the gradation characteristics of the respective modalities 12 and the luminance setting of the monitor 16. As a further advantage, image display is possible with the gradation characteristics of the monitor 16 being fully exploited to provide a smooth gradation.

In the example under consideration, gradation corrections by the modality LUTs are performed in the processor 14; however, this is not the sole case of the present invention and the monitor 16 may be so configured that it is furnished with the LUT memory to be capable of performing gradation corrections by the modality LUTs.

The method described in the foregoing example is such that a gradation correcting table that has been preliminarily constructed for each modality in association with its gradation characteristics and with the luminance setting and gradation characteristics of the monitor is employed to perform optimum gradation correction on each set of image data and the thus corrected images are displayed on the monitor. It should, however, be noted that in the present invention, not only the luminance but also correction coefficients that are associated with the setting of the color temperature may be employed to display images of optimum gradations on the monitor. This alternative method is described below in detail.

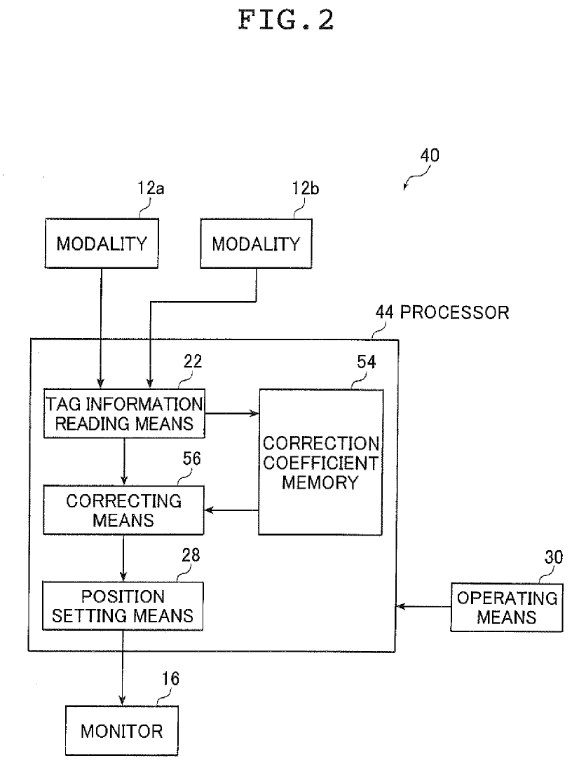

FIG. 2 is a block diagram showing a second embodiment of the image display system having the image processing apparatus of the present invention.

The image display system is generally shown by numeral 40 in FIG. 2 and except for a correction coefficient memory 54 and a correcting means 56, it is essentially the same as the system shown in FIG. 1; hence, like parts are identified by like numerals in FIG. 2 and the following explanation is concentrated on those parts which differ from the system shown in FIG. 1.

Referring to the image display system 40 shown in FIG. 2, the correction coefficient memory 54 is a memory that stores the correction coefficients for performing gradation corrections that are associated with the respective modalities 12. In other words, as many correction coefficients as the modalities are constructed and stored in the correction coefficient memory 54.

The correction coefficients as used herein are those for effecting gradation correction which are preliminarily calculated in association with the color temperatures of the respective modalities 12, as well as with the color temperature setting and gradation characteristics of the monitor 16.

In short, as many correction coefficients as the modalities 12 are constructed and stored in the correction coefficient memory 54.

The correction coefficients are used to perform gradation corrections on mages supplied from different modalities 12 when the images are displayed together on one monitor. In the illustrated case, the monitor 16 has its color temperature set in association with the modality 12 for which the highest display luminance is required. The correction coefficients are constructed for each modality 12 such that in accordance with the color temperature setting of the monitor 16 as combined with a particular modality 12, the image displayed on the monitor 16 will have the appropriate gradation characteristics that are associated with that modality 12. In one example, the correction coefficients may be so adapted as to change RGB gains for the gradation correction to be performed in an analog fashion. Alternatively, a limited number of correction coefficients may be provided as discrete parameters, which are then interpolated to achieve the intended gradation correction.

The correction coefficient memory 54 stores these correction coefficients.

By being thus furnished with the correction coefficients for gradation correction that have been set for the respective modalities 12, the illustrated processor 44 has the advantage that when a plurality of images supplied from different modalities 12 are displayed together on the monitor 16, each image can be processed to have the appropriate gradation characteristics that are associated with the modality 12 from which it has been supplied; as a result, high-quality diagnostic images are displayed together to ensure that accurate and appropriate diagnosis can be performed rapidly.

With the image display system 40, the correction coefficients may be stored in the correction coefficient memory 54 after being constructed externally; alternatively, they may be stored in the correction coefficient memory 54 after being constructed automatically within the processor 44 in response to a change in the color temperature setting of the monitor 16 or the like.

Note that the correction coefficients may be constructed by a known method that is generally employed to construct correction coefficients used in gradation corrections that are performed on a monitor for the single-mode display.

In a preferred mode of the correction coefficients, if the display capacity of the monitor 16 (the number of gradations in a display) is higher than the number of gradations in the input image data, the correction coefficients are used not only to perform the above-described gradation corrections but also to expand the gradations in the image data to match the display capacity of the monitor 16.

Alternatively, the correcting means 56 may be furnished with LUTs that not only correct but also expand the gradation of the monitor 16 and use such LUTs to correct and expand the gradation of the input image.

The correction coefficient memory 54, having received from the tag information reading means 22 the result of identification of the modality 12 from which a particular image was sent, uses that result of identification to search for the correction coefficients associated with that modality 12 and sends the pertinent correction coefficients to the correcting means 56.

Using the correction coefficients it has received from the correction coefficient memory 54, the correcting means 56 performs gradation correction on the image data.

In the next place, the method of correcting the gradation of the image data in the image display system 40 of the present invention and the method of displaying images with that system are described in detail.

As in the first embodiment, each of the modalities 12 attaches an identification tag to the image data of a diagnostic picture it has taken or the image data of a diagnostic picture it has read from an external imaging medium, and outputs such image data to the processor 44.

The processor 44, having received the image data and the identification tags, reads the tag information on the image data in the tag information reading means 22, and identifies the modalities 12 from which the image data have been sent. The information about the identified modalities 12 is forwarded to the correction coefficient memory 54.

The correction coefficient memory 54, having received from the tag information reading means 22 the result of identification of the modality 12 from which a particular image was sent, uses that result of identification to search for the correction coefficients for that modality 12 and sends the pertinent correction coefficients to the correcting means 56. Using the correction coefficients it has received, the correcting means 56 performs the gradation correcting procedure on the image data.

The image data that have been subjected to the gradation correction are sent to the position setting means 28.

The position setting means 28 sets the positions on the screen in which the image data it has received are to be displayed on the monitor 16. The setting procedure may be the same as already described in the first embodiment.

When the display positions have been determined, the processor 44 supplies the monitor 16 with both the gradation-corrected image data and the position information which shows the positions in which the image data are to be displayed.

The monitor 16, having received the image data and the position information from the processor 44, uses that position information to determine the positions on the screen in which the image data are to be displayed, and subsequently displays the respective images.

According to the image display system 40 having the image processing apparatus 44 described above, by using the correction coefficients that are associated with the respective modalities 12, gradation corrections can be performed in association with the gradation characteristics of those modalities 12 and with the color temperature of the monitor 16. As a result, even when a monochromatic image is displayed together with a color image, the two images can be easily reproduced to have optimum gradations that are associated with the color temperatures of the respective modalities 12 and the color temperature setting of the monitor 16. As a further advantage, image display is possible with the gradation characteristics of the monitor 16 being fully exploited to provide a smooth gradation.

In the example under consideration, the correction coefficients are preliminarily stored in the correction coefficient memory 54 and searched through as required; however, this is not the sole case of the present invention and a following alternative may be adopted: the correction coefficients are not stored preliminarily but each time the processor 44 receives image data, they are calculated, for example, in the correcting means 56 on the basis of the color temperatures of the respective modalities 12 and the color temperature setting of the monitor 16 and subsequently applied.

According to the present invention described above, if a plurality of images sent from different modalities are to be simultaneously displayed on one monitor, they are subjected to gradation corrections that are associated with the gradation characteristics of the respective modalities and with the luminance or color temperature setting of the monitor; as a result, even when a monochromatic image is displayed together with a color image, the two images can be easily reproduced to have optimum gradations.

As a further advantage, when the image is expanded to match the number of bits on the monitor, gradation correction is performed on each image in association with the gradation characteristics of the monitor; therefore, image display is possible with the gradation characteristics of the monitor being fully exploited to provide a smooth gradation.

While the image processing apparatus of the present invention has been described above in detail, the present invention is by no means limited to the foregoing embodiments and it should of course be understood that various improvements and modifications are possible without departing from the scope and spirit of the invention.

What is claimed is:

1. An image processing apparatus that performs image processing on diagnostic images from medical diagnostic apparatuses and produces output images on a monitor, comprising:
identifying means which identifies respective types of said medical diagnostic apparatuses from which said diagnostic images have been sent;
correcting means which has correcting conditions as set for said respective types of said medical diagnostic apparatuses and which performs gradation corrections on said diagnostic images under one of said correcting conditions corresponding to one type of said medical diagnostic apparatuses as identified by said identifying means; and
position setting means which sets positions on a display screen of said monitor in which said diagnostic images are to be displayed.

2. The image processing apparatus according to claim 1, wherein said correcting conditions are look-up tables for processing said diagnostic images.

3. The image processing apparatus according to claim 2, wherein said look-up tables are also used to expand number of gradations in said diagnostic images to match display capacity of said monitor.

4. The image processing apparatus according to claim 1, wherein said correcting conditions are either correction coefficients in mathematical operations for correcting said diagnostic images or means for calculating the correction coefficients in the mathematical operations for correcting said diagnostic images, or both.

5. The image processing apparatus according to claim 4, wherein said mathematical operations also expand number of gradations in said diagnostic images to match display capacity of said monitor.
